(19) United States
(12) Patent Application Publication
(10) Pub. No.: US 2013/0063121 A1
(43) Pub. Date: Mar. 14, 2013

(54) SHORT-CIRCUIT PROTECTION CIRCUIT AND DC-DC CONVERTER

(71) Applicant: Kei KASAI, Tokyo (JP)

(72) Inventor: Kei KASAI, Tokyo (JP)

(73) Assignee: KABUSHIKI KAISHA TOSHIBA, Tokyo (JP)

(21) Appl. No.: 13/423,679

(22) Filed: Mar. 19, 2012

(30) Foreign Application Priority Data
Sep. 13, 2011 (JP) 2011-199473

(51) Int. Cl. G05F 3/08; H02H 9/04

(52) U.S. Cl. 323/311; 361/18

(57) ABSTRACT

The short-circuit protection circuit includes a first logic circuit that outputs the first logic signal so as to turn off the fourth MOS transistor in a case where the first gate voltage signal has a value that turns on the first MOS transistor and the switching terminal has a terminal voltage between a predetermined first threshold value and the second potential. The short-circuit protection circuit includes a first detecting circuit that compares a first detected voltage between the second end of the first resistor and the first end of the third MOS transistor with a predetermined first reference voltage and outputs, in a case where the first detected voltage is closer to the second potential than the first reference voltage, a first detection signal indicating that the switching terminal and the second potential are short-circuited.

### CROSS-REFERENCE TO RELATED APPLICATION

This application is based upon and claims the benefit of priority from the prior Japanese Patent Application

No. 2011-199473, filed on Sep. 13, 2011, the entire contents of which are incorporated herein by reference.

### FIELD

Embodiments described herein relate generally to a short-circuit protection circuit and a DC-DC converter.

### BACKGROUND

In recent years, the on resistances of output devices such as a step-down DC-DC converter have been reduced in response to microfabrication in processes, leading to a larger short-circuit current in the event of a short circuit of a switching terminal.

Thus, in order to protect an output device in the event of a short circuit of a switching terminal in a DC-DC converter, it is necessary to more quickly detect a short circuit of the switching terminal and turn off the output device.

### BRIEF DESCRIPTION OF THE DRAWINGS

FIG. 1 is a circuit diagram showing an example of the circuit configuration of a DC-DC converter 100 according to a first embodiment;

FIG. 2 is a diagram showing an example of a specific circuit configuration of a first detecting circuit 2 illustrated in FIG. 1;

FIG. 3 is a diagram showing an example of a specific circuit configuration of a second detecting circuit 5 illustrated in FIG. 1;

FIG. 4 is a diagram showing an example of operating waveforms of the DC-DC converter 100 in a case where a first MOS transistor is turned on or off under normal conditions (in an absence of a ground fault);

FIG. 5 is a diagram showing an example of operating waveforms of the DC-DC converter 100 in an event of a ground fault when a first MOS transistor is turned on or off;

FIG. 6 is a diagram showing an example of operating waveforms of the DC-DC converter 100 in the case where the first MOS transistor is turned on or off in an event of a ground fault;

FIG. 7 is a diagram showing an example of a circuit configuration featuring a configuration for detecting a ground fault of a short-circuit protection circuit according to a first modification; and

FIG. 8 is a diagram showing an example of a circuit configuration featuring a configuration for detecting a ground fault of a short-circuit protection circuit according to a second modification.

### DETAILED DESCRIPTION

A DC-DC converter according to an embodiment includes a first MOS transistor of a first conductivity type having a first end supplied with a first potential, a second end connected to a switching terminal, and a gate supplied with a first gate voltage signal. The DC-DC converter includes a second MOS transistor of a second conductivity type having a first end connected to the switching terminal, a second end supplied with a second potential, and a gate supplied with a second gate voltage signal. The DC-DC converter includes a controller that controls the first gate voltage signal and the second gate voltage signal to complementarily turn on or off the first MOS transistor and the second MOS transistor. The DC-DC converter includes a short-circuit protection circuit configured to detect a short circuit between the switching terminal and the first potential or the second potential, and output a detection signal to the controller.

The short-circuit protection circuit includes a first resistor having a first end supplied with the first potential. The short-circuit protection circuit includes a third MOS transistor of the first conductivity type having a first end connected to a second end of the first resistor, a second end connected to the switching terminal, and a gate supplied with the first gate voltage signal, the third MOS transistor being turned on or off in synchronization with the first MOS transistor. The short-circuit protection circuit includes a fourth MOS transistor of the first conductivity type connected in parallel with the first resistor between the first potential line and the first end of the third MOS transistor, and controlled by a first logic signal. The short-circuit protection circuit includes a first logic circuit outputting the first logic signal so as to turn off the fourth MOS transistor in a case where the first gate voltage signal has a value that turns on the first MOS transistor and the switching terminal has a terminal voltage between a predetermined first threshold value and the second potential. The short-circuit protection circuit includes a first detecting circuit comparing a first detected voltage between the second end of the first resistor and the first end of the third MOS transistor with a predetermined first reference voltage and outputting, in a case where the first detected voltage is closer to the second potential than the first reference voltage, a first detection signal indicating that the switching terminal and the second potential are short-circuited.

Hereafter, a short-circuit protection circuit and a DC-DC converter according to the present invention will be described more specifically with reference to the drawings. Embodiments will be described below with reference to the accompanying drawings. In the following embodiments, a first potential line is connected to a power supply potential, a second power supply line is connected to a ground potential, a MOS transistor of a first conductivity type is a pMOS transistor, and a MOS transistor of a second conductivity type is an nMOS transistor. The same explanation is applicable in the case where the polarity of the circuit is reversed, that is, in the case where the first potential line is connected to the ground potential, the second power supply line is connected to the power supply potential, the MOS transistor of the first conductivity type is an nMOS transistor, and the MOS transistor of the second conductivity type is a pMOS transistor.

### FIRST EMBODIMENT

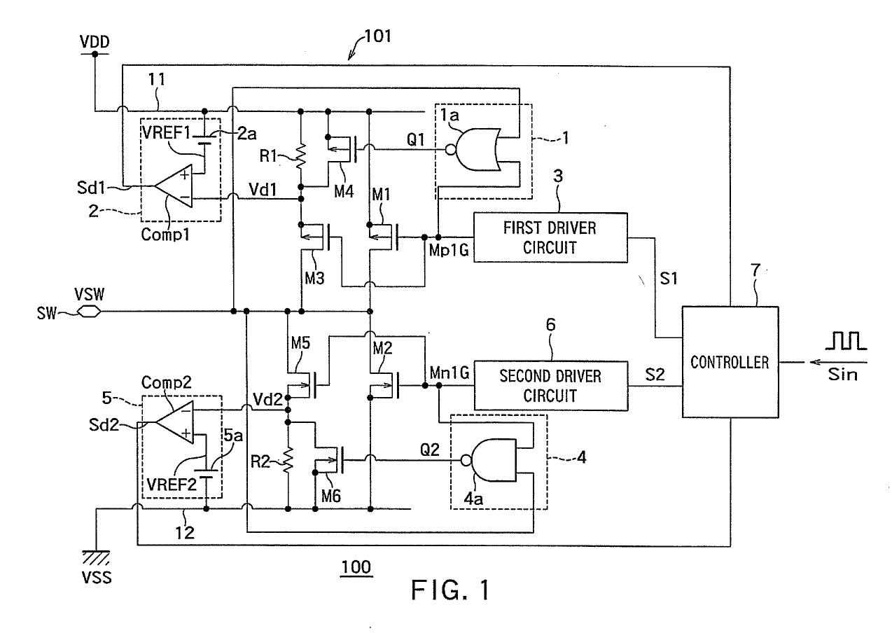

FIG. 1 is a circuit diagram illustrating an example of the circuit configuration of a DC-DC converter 100 according to a first embodiment.

As illustrated in FIG. 1, the DC-DC converter 100 includes a first MOS transistor (pMOS transistor) M1 of a first conductivity type as an output device, a second MOS transistor (nMOS transistor) M2 of a second conductivity type as an output device, a first driver circuit 3, a second driver circuit 6, a controller 7, a short-circuit protection circuit 101, and a switching terminal SW.

The first MOS transistor M1 has one end (source) connected to a first potential line 11 connected to a power supply potential VDD (first potential), the other end (drain) connected to the switching terminal SW, and a gate supplied with a first gate voltage signal Mp1G. In other words, the power supply potential VDD is applied to one end (source) of the first MOS transistor M1. The power supply potential VDD may be applied to one end (source) of the first MOS transistor M1 through a circuit or a device, not shown (also to other constituent elements).

The second MOS transistor M2 has one end (drain) connected to the switching terminal SW, the other end (source) connected to a second potential line 12 connected to a ground potential VSS, and a gate supplied with a second gate voltage signal Mn1G. In other words, the ground potential VSS is applied to the other end (source) of the second MOS transistor M2. The ground potential VSS may be applied to the other end (source) of the second MOS transistor M2 through a circuit or a device, not shown (also to other constituent elements).

The controller 7 controls a first control signal S1 and a second control signal S2, that is, the first gate voltage signal Mp1G and the second gate voltage signal Mn1G in response to a switching control signal Sin. Thus, the first MOS transistor M1 and the second MOS transistor M2 are complementarily turned on and off. Specifically, when the first MOS transistor M1 is turned on, the second MOS transistor M2 is turned off, whereas when the first MOS transistor is turned off, the second MOS transistor M2 is turned on.

The controller 7 controls the first MOS transistor M1 and the second MOS transistor M2 in this manner, allowing the DC-DC converter 100 to output a predetermined voltage from the switching terminal SW.

Furthermore, the controller 7 turns off the first and second MOS transistors M1 and M2 by controlling the first and second gate voltage signals Mp1G and Mn1G in response to first and second detection signals Sd1 and Sd2.

The first driver circuit 3 amplifies the first control signal S1 outputted from the controller 7 and outputs the first gate voltage signal Mp1G.

The second driver circuit 6 amplifies the second control signal S2 outputted from the controller 7 and outputs the second gate voltage signal Mn1G.

The short-circuit protection circuit 101 detects a short circuit (that is, a lightning fault or a ground fault) between the switching terminal SW and the power supply potential VDD or the ground potential VSS and outputs the first and second detection signals Sd1 and Sd2 based on the detection result to the controller 7.

As illustrated in FIG. 1, the short-circuit protection circuit 101 includes a first logic circuit 1, a first detecting circuit 2, a first resistor R1, a third MOS transistor (pMOS transistor) M3 of the first conductivity type, and a fourth MOS transistor (pMOS transistor) M4 of the first conductivity type.

The first resistor R1 has one end connected to the first potential line 11. In other words, the power supply potential VDD is applied to one end of the first resistor R1.

The third MOS transistor M3 has one end (source) connected to the other end of the first resistor R1 and the other end (drain) connected to the switching terminal SW. Moreover, the third MOS transistor M3 has a gate supplied with the first gate voltage signal Mp1G and is turned on or off in synchronization with the first MOS transistor M1. In other words, when the first MOS transistor M1 is turned on, the third MOS transistor M3 is turned on, whereas when the first MOS transistor M1 is turned off, the third MOS transistor M3 is turned off.

The fourth MOS transistor M4 is connected in parallel with the first resistor R1 between the first potential line 11 and one end (source) of the third MOS transistor M3. The fourth MOS transistor M4 is controlled by a first logic signal Q1.

In the case where the first gate voltage signal Mp1G has a value that turns on the first MOS transistor M1 and the switching terminal SW has a terminal voltage VSW between a predetermined first threshold value Vth1 and the ground potential VSS, the first logic circuit 1 outputs the first logic signal Q1 so as to turn off the fourth MOS transistor M4.

In the case where the first gate voltage signal Mp1G has a value that turns off the first MOS transistor M1 or the terminal voltage VSW is obtained between the first threshold value Vth1 and the first potential, the first logic circuit 1 outputs the first logic signal Q1 so as to turn off the fourth MOS transistor M4.

As illustrated in FIG. 1, the first logic circuit 1 includes, for example, a NOR circuit la that has an input connected to the switching terminal SW and the gate of the first MOS transistor M1 and an output connected to the gate of the fourth MOS transistor M4, and outputs the first logic signal Q1.

The first detecting circuit 2 compares a first detected voltage Vd1 between the other end of the first resistor R1 and one end of the third MOS transistor M3 with a predetermined first reference voltage VREF1.

In a comparison between the first detected voltage Vd1 and the first reference voltage VREF1, in the case where the first detected voltage Vd1 is closer to the ground potential VSS than the first reference voltage VREF1, the first detecting circuit 2 outputs a first detection signal Sd1 indicating that the switching terminal SW and the ground potential VSS are short-circuited (for example, the first detection signal Sd1 is set at “High” level).

The controller 7 turns off the first MOS transistor M1 by controlling the first gate voltage signal Mp1G in response to the first detection signal Sd1 (“High” level).

Thus, a current passing through the first MOS transistor M1 is limited, thereby suppressing a failure of the first MOS transistor M1 in the event of a ground fault of the switching terminal SW.

In a comparison between the first detected voltage Vd1 and the first reference voltage VREF1, in the case where the first reference voltage VREF1 is closer to the ground potential VSS than the first detected voltage Vd1, the first detecting circuit 2 does not output the first detection signal Sd1 (for example, the first detection signal Sd1 is set at “Low” level).

As illustrated in FIG. 1, the first detecting circuit 2 includes, for example, a first voltage source 2a that outputs the first reference voltage VREF1 and a first comparator Comp1 that compares the first reference voltage VREF1 and the first detected voltage Vd1 and outputs the first detection signal Sd1 according to the comparison result.

As illustrated in FIG. 1, the short-circuit protection circuit 101 includes a second resistor R2, a fifth MOS transistor (nMOS transistor) M5 of the second conductivity type, a sixth MOS transistor M6 of the second conductivity type, a second logic circuit 4, and a second detecting circuit 5.

The second resistor R2 has one end connected to the second potential line 12. In other words, the ground potential VSS is applied to one end of the second resistor R2.

The fifth MOS transistor M5 has one end (source) connected to the other end of the second resistor R2 and the other end (drain) connected to the switching terminal SW. Moreover, the fifth MOS transistor M5 has a gate supplied with the second gate voltage signal Mn1G and is turned on or off in synchronization with the second MOS transistor M2. In other words, the fifth MOS transistor M5 is turned on in synchronization with the second MOS transistor M2 turning on, whereas the fifth MOS transistor M5 is turned off in synchronization with the second MOS transistor M2 turning off

The sixth MOS transistor M6 is connected in parallel with the second resistor R2 between the second potential line 12 and one end (source) of the fifth MOS transistor M5. The sixth MOS transistor is controlled by a second logic signal Q2.

In the case where the second gate voltage signal Mn1G has a value that turns on the second MOS transistor M2 and the terminal voltage VSW is obtained between a predetermined second threshold value Vth2 and the power supply potential VDD, the second logic circuit 4 outputs the second logic signal Q2 so as to turn off the sixth MOS transistor M6.

In the case where the second gate voltage signal Mn1G has a value that turns off the second MOS transistor M2 or the terminal voltage VSW is obtained between the second threshold value Vth2 and the ground potential VSS, the second logic circuit 4 outputs the second logic signal Q2 so as to turn off the sixth MOS transistor M6.

The second logic circuit 4 includes, for example, a NAND circuit 4a that has an input connected to the switching terminal SW and the gate of the second MOS transistor M2 and an output connected to the gate of the sixth MOS transistor M6, and outputs the second logic signal Q2.

The second detecting circuit 5 compares a second detected voltage Vd2 between the other end of the second resistor R2 and one end (source) of the fifth MOS transistor M5 and a predetermined second reference voltage VREF2.

For example, in a comparison between the second detected voltage Vd2 and the second reference voltage VREF2, in the case where the second detected voltage Vd2 is closer to the power supply potential VDD than the second reference voltage VREF2, the second detecting circuit 5 outputs a second detection signal Sd2 indicating that the switching terminal SW and the power supply potential VDD are short-circuited (for example, the second detection signal Sd2 is set at “High” level).

The controller 7 turns off the second MOS transistor M2 by controlling the second gate voltage signal Mn1G in response to the second detection signal Sd2 (“High” level).

Thus, a current passing through the second MOS transistor M2 is limited, thereby suppressing a failure of the second MOS transistor M2 in the event of a ground fault of the switching terminal SW.

In a comparison between the second detected voltage Vd2 and the second reference voltage VREF2, in the case where the second reference voltage VREF2 is closer to the power supply potential VDD than the second detected voltage Vd2, the second detecting circuit 5 does not output the second detection signal Sd2 (for example, the second detection signal Sd2 is set at “Low” level).

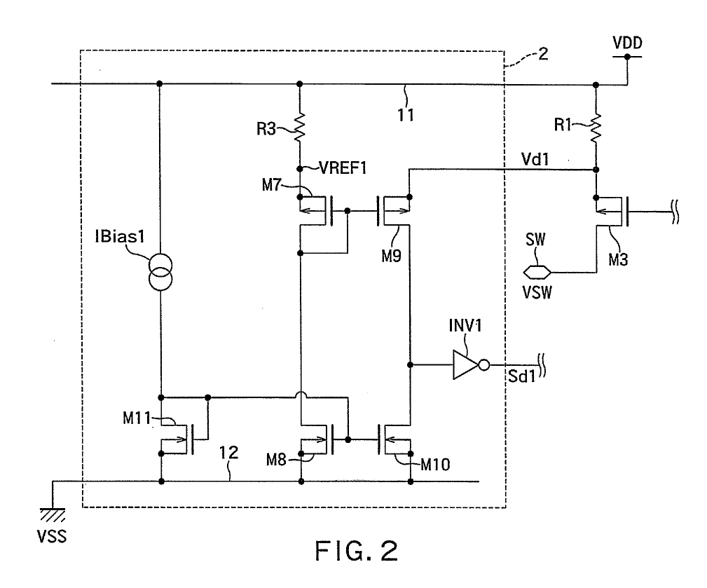

FIG. 2 illustrates an example of a specific circuit configuration of the first detecting circuit 2 illustrated in FIG. 1.

The first detecting circuit 2 includes a third resistor R3, a seventh MOS transistor (pMOS transistor) M7 of the first conductivity type, an eighth MOS transistor (pMOS transistor) M8 of the second conductivity type, a ninth MOS transistor (pMOS transistor) M9 of the first conductivity type, a tenth MOS transistor (nMOS transistor) M10 of the second conductivity type, a first constant current source IBias1, an eleventh MOS transistor M11 of the second conductivity type, and a first inverter INV1.

The third resistor R3 has one end connected to the first potential line 11. In other words, the power supply potential VDD is applied to one end of the third resistor R3.

The seventh MOS transistor M7 is diode-connected and has one end (source) connected to the other end of the third resistor R3.

The eighth MOS transistor M8 has one end (drain) connected to the other end (drain) of the seventh MOS transistor M7 and the other end (source) connected to the second potential line 12. In other words, the ground potential VSS is applied to the other end (source) of the eighth MOS transistor M8.

The ninth MOS transistor M9 has one end (source) connected to the other end of the first resistor R1 and a gate connected to the gate of the seventh MOS transistor M7.

The tenth MOS transistor M10 has one end (drain) connected to the other end (drain) of the ninth MOS transistor M9, the other end (source) connected to the second potential line 12, and a gate connected to the gate of the eighth MOS transistor M8. In other words, the ground potential VSS is applied to the other end (source) of the tenth MOS transistor M10.

The first constant current source IBias1 has one end connected to the first potential line 11 and outputs a constant current. In other words, the power supply potential VDD is applied to one end of the first constant current source IBias1.

The eleventh MOS transistor M11 is diode-connected and has one end (drain) connected to the other end of the first constant current source IBias1, the other end (source) connected to the second potential line 12, and a gate connected to the gate of the eighth MOS transistor M8. In other words, the ground potential VSS is applied to the other end (source) of the eleventh MOS transistor M11.

The first inverter INV1 is supplied with a voltage between the other end (drain) of the ninth MOS transistor M9 and one end (drain) of the tenth MOS transistor M10 and outputs the first detection signal Sd1. In other words, the first inverter INV1 outputs the first detection signal Sd1 based on the voltage between the other end of the ninth MOS transistor M9 and one end of the tenth MOS transistor M10.

The first detecting circuit 2 configured thus outputs the first detection signal Sd1 based on a comparison result of the first detected voltage Vd1 on the other end of the first resistor R1 and the first reference voltage VREF1 on the other end of the third resistor R3.

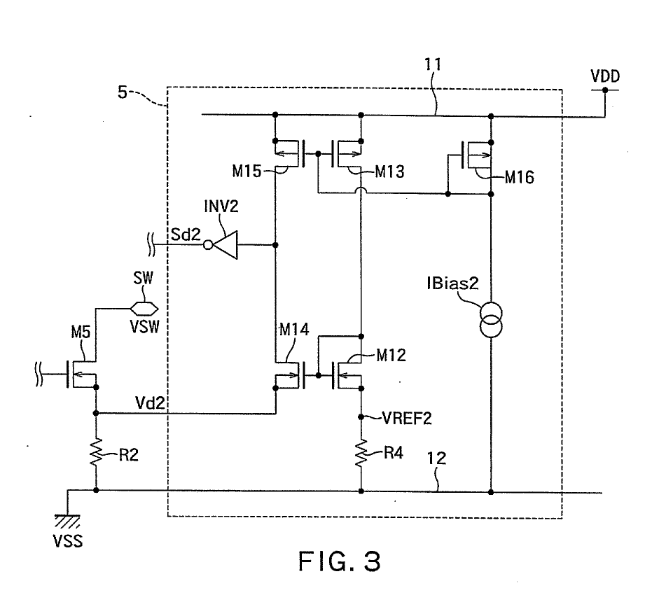

FIG. 3 illustrates an example of a specific circuit configuration of the second detecting circuit 5 illustrated in FIG. 1.

As illustrated in FIG. 3, the second detecting circuit 5 includes, for example, a fourth resistor R4, a twelfth MOS transistor (nMOS transistor) M12 of the second conductivity type, a thirteenth MOS transistor (pMOS transistor) M13 of the first conductivity type, a fourteenth MOS transistor (nMOS transistor) M14 of the second conductivity type, a fifteenth MOS transistor (pMOS transistor) M15 of the first conductivity type, a sixteenth MOS transistor (pMOS transistor) M16 of the first conductivity type, a second constant current source IBias2, and a second inverter INV2.

The fourth resistor R4 has one end connected to the second potential line 12. In other words, the ground potential VSS is applied to one end of the fourth resistor R4.

The twelfth MOS transistor M12 is diode-connected and has one end (source) connected to the other end of the fourth resistor R4.

The thirteenth MOS transistor M13 has one end (drain) connected to the other end (drain) of the twelfth MOS transistor M12 and the other end (source) connected to the first potential line 11. In other words, the power supply potential VDD is applied to the other end (source) of the thirteenth MOS transistor M13.

The fourteenth MOS transistor M14 has one end (source) connected to the other end of the second resistor R2 and a gate connected to the gate of the twelfth MOS transistor M12.

The fifteenth MOS transistor M15 has one end (drain) connected to the other end (drain) connected to the fourteenth MOS transistor M14, the other end (source) connected to the first potential line 11, and a gate connected to the gate of the thirteenth MOS transistor M13. In other words, the power supply potential VDD is applied to the other end (source) of the fifteenth MOS transistor M15.

The second constant current source IBias2 has one end connected to the second potential line 12 and outputs a constant current. In other words, the ground potential VSS is applied to one end of the second constant current source IBias2.

The sixteenth MOS transistor M16 is diode-connected and has one end (drain) connected to the other end of the second constant current source, the other end (source) connected to the first potential line 11, and a gate connected to the gate of the thirteenth MOS transistor M13. In other words, the power supply potential VDD is applied to the other end (source) of the sixteenth MOS transistor M16.

The second inverter INV2 is supplied with a voltage between the other end (drain) of the fourteenth MOS transistor M14 and one end (drain) of the fifteenth MOS transistor M15 and outputs the second detection signal Sd2. In other words, the second inverter INV2 outputs the second detection signal Sd2 based on the voltage between the other end (drain) of the fourteenth MOS transistor M14 and one end (drain) of the fifteenth MOS transistor M15.

The second detecting circuit 5 configured thus outputs the second detection signal Sd2 based on a comparison result of the second detected voltage Vd2 on the other end of the second resistor R2 and the second reference voltage VREF2 on the other end of the fourth resistor R4.

An example of short-circuit protection of the DC-DC converter 100 configured thus will be described below. The following will discuss an example of short-circuit protection in the event of a ground fault. Short-circuit protection in the event of a lightning fault can be similarly explained by reversing the polarity of the circuit.

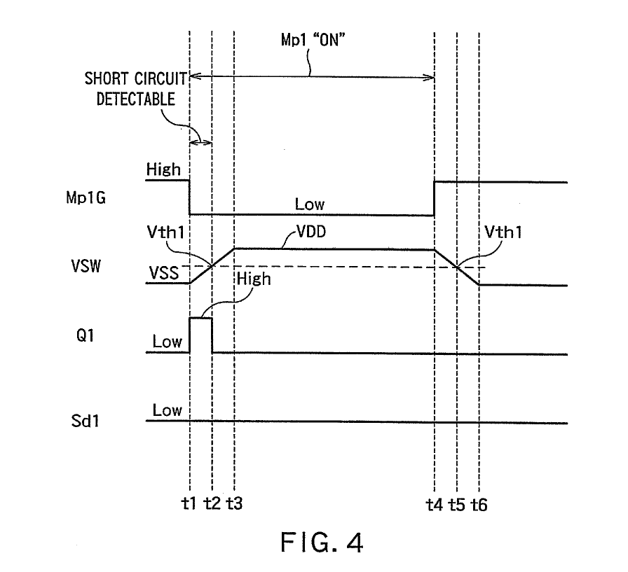

FIG. 4 shows an example of the operating waveforms of the DC-DC converter 100 in the case where the first MOS transistor is turned on or off under normal conditions (in the absence of a ground fault).

As shown in FIG. 4, at time t1, the first gate voltage signal Mp1G changes from “High” level to “Low” level, so that the first MOS transistor M1 is turned on (the second MOS transistor M2 is turned off) and the terminal voltage VSW starts rising. Furthermore, the first logic circuit 1 changes the first logic signal Q1 to “High” level in response to the change of the first gate voltage signal Mp1G to “Low” level.

Since the first gate voltage signal Mp1G has a value that turns on the first MOS transistor M1 and the terminal voltage VSW is obtained between the first threshold value Vth1 and the ground potential VSS, the first logic circuit 1 outputs the first logic signal Q1 (“High” level) so as to turn off the fourth MOS transistor M4 (times t1 to t2).

In a period during which the first logic signal Q1 is at “High” level (times t1 to t2), the fourth MOS transistor M4 is turned off. Thus, the first detecting circuit 2 can compare the first reference voltage VREF1 and a voltage drop, as the first detected voltage Vd1, in the first resistor R1.

From time t2, the terminal voltage VSW is set between the first threshold value Vth1 and the first potential. Thus, the first logic circuit 1 outputs the first logic signal Q1 (“Low” level) so as to turn off the fourth MOS transistor M4.

At time t3, the terminal voltage VSW changes to the power supply potential VDD.

Then, at time t4, the first gate voltage signal Mp1G changes from “Low” level to “High” level, so that first MOS transistor M1 is turned off (the second MOS transistor M2 is turned on) and the terminal voltage VSW starts falling. The first logic circuit 1 sets the first logic signal Q1 at “Low” level regardless of the value of the terminal voltage VSW in response to the change of the first gate voltage signal Mp1G to “High” level.

At time t6, the terminal voltage VSW changes to the ground potential VSS.

In a switching time during which the first MOS transistor M1 is turned on, the rising time of the switching terminal SW is delayed relative to the change of the first gate voltage signal Mp1G. Thus, from the falling edge of the first gate voltage signal Mp1G to the rising edge of the switching terminal SW (up to the first threshold value Vth1 of the first logic circuit 1), the fourth MOS transistor M4 is turned off and the first detecting circuit 2 can detect an overcurrent.

In such a normal operation, an overcurrent does not occur. Thus, the first detecting circuit 2 does not detect an overcurrent and does not affect the operation.

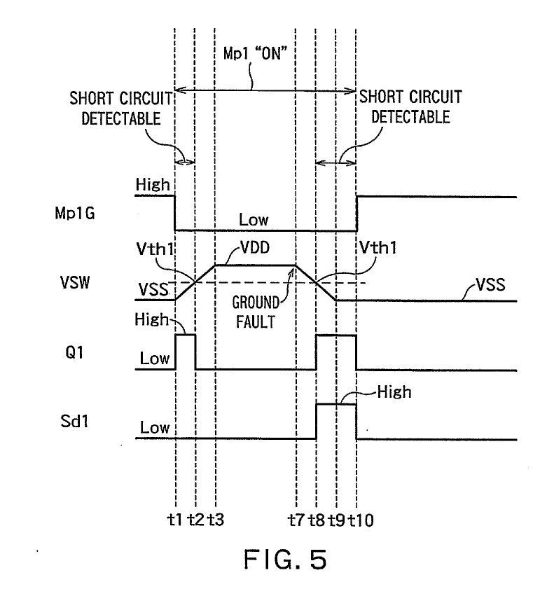

FIG. 5 illustrates an example of the operating waveforms of the DC-DC converter 100 in the event of a ground fault when the first MOS transistor is turned on or off.

As shown in FIG. 5, from time t1 to time t3, the changes of the waveforms are identical to those of FIG. 4.

At time t7, the terminal voltage VSW starts falling in the event of a ground fault.

Then, at time t8, the first logic circuit 1 sets the first logic signal Q1 at “High” level when the terminal voltage VSW falls to or below the first threshold value Vth1.

At time t9, the terminal voltage VSW changes to the ground potential VSS.

At time t10, the first gate voltage signal Mp1G changes to “High” level, so that the first MOS transistor M1 is turned on (the second MOS transistor M2 is turned off). Moreover, the first logic circuit 1 sets the first logic signal Q1 at “Low” level in response to the change of the first gate voltage signal Mp1G to “High” level.

Specifically, in the case where the first gate voltage signal Mp1G has a value that turns on the first MOS transistor M1 and the terminal voltage VSW is obtained between the first threshold value Vth1 and the ground potential VSS, the first logic circuit 1 outputs the first logic signal Q1 (“High” level) so as to turn off the fourth MOS transistor M4 (times t8 to t10).

In a period during which the first logic signal Q1 is at “High” level (times t8 to t10), the fourth MOS transistor M4 is turned off. Thus, the first detecting circuit 2 can compare the first reference voltage VREF1 and a voltage drop, as the first detected voltage Vd1, in the first resistor R1.

Hence, the first detecting circuit 2 decides that the first detected voltage Vd1 is closer to the ground potential VSS than the first reference voltage VREF1, and outputs the first detection signal Sd1 (“High” level) indicating that the switching terminal SW and the ground potential VSS are short-circuited (times t8 to t10).

The controller 7 turns off the first MOS transistor M1 by controlling the first gate voltage signal Mp1G in response to the first detection signal Sd1 (“High” level).

Thus, a current passing through the first MOS transistor M1 is limited, thereby suppressing a failure of the first MOS transistor M1 in the event of a ground fault of the switching terminal SW.

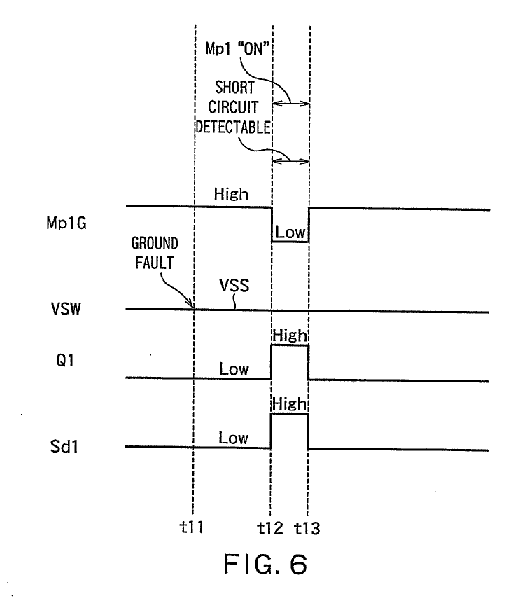

FIG. 6 shows an example of the operating waveforms of the DC-DC converter 100 in the case where the first MOS transistor is turned on or off in the event of a ground fault.

As shown in FIG. 6, a ground fault occurs (time t11) in a state in which the first gate voltage signal Mp1G is at “High” level, that is, the first MOS transistor M1 is turned off (the second MOS transistor M2 is turned on). Since the second MOS transistor M2 is turned on, the terminal voltage VSW remains constant.

At time t12, the first gate voltage signal Mp1G changes from “High” level to “Low” level, so that the first MOS transistor M1 is turned on (the second MOS transistor M2 is turned off). Moreover, the first logic circuit 1 changes the first logic signal Q1 to “High” level in response to the change of the first gate voltage signal Mp1G to “Low” level.

Since the first gate voltage signal Mp1G has a value that turns on the first MOS transistor M1 and the terminal voltage VSW is obtained between the first threshold value Vth1 and the ground potential VSS, the first logic circuit 1 outputs the first logic signal Q1 (“High” level) so as to turn off the fourth MOS transistor M4 (times t12 to t13).

Thus, in a period during which the first logic signal Q1 is at “High” level (times t12 to t13), the fourth MOS transistor M4 is turned off. This allows the first detecting circuit 2 to compare the first reference voltage VREF1 and a voltage drop, as the first detected voltage Vd1, in the first resistor R1.

Then, the first detecting circuit 2 decides that the first detected voltage Vd1 is closer to the ground potential VSS than the first reference voltage VREF1, and outputs the first detection signal Sd1 (“High” level) indicating that the switching terminal SW and the ground potential VSS are short-circuited (times t12 to t13).

The controller 7 turns off the first MOS transistor M1 by controlling the first gate voltage signal Mp1G in response to the first detection signal Sd1 (“High” level).

Thus, a current passing through the first MOS transistor M1 is limited, thereby suppressing a failure of the first MOS transistor M1 in the event of a ground fault of the switching terminal SW.

As described above, the short-circuit protection circuit 101 according to the first embodiment can more quickly detect a short circuit condition of the switching terminal SW.

The short-circuit protection circuit 101 configured thus is applicable to the DC-DC converter 100. The DC-DC converter 100 including the short-circuit protection circuit 101 more quickly detects a short circuit condition of the switching terminal SW and limits currents passing through the first and second MOS transistors M1 and M2, which are output devices, according to the detection result. Thus, failures of the first and second MOS transistors M1 and M2 can be suppressed with higher reliability.

### First Modification

A first modification will describe an example of a configuration for indirectly detecting a terminal voltage VSW in the case where a potential difference between a power supply potential VDD and a ground potential VSS is not smaller than the operating voltage of a logic circuit.

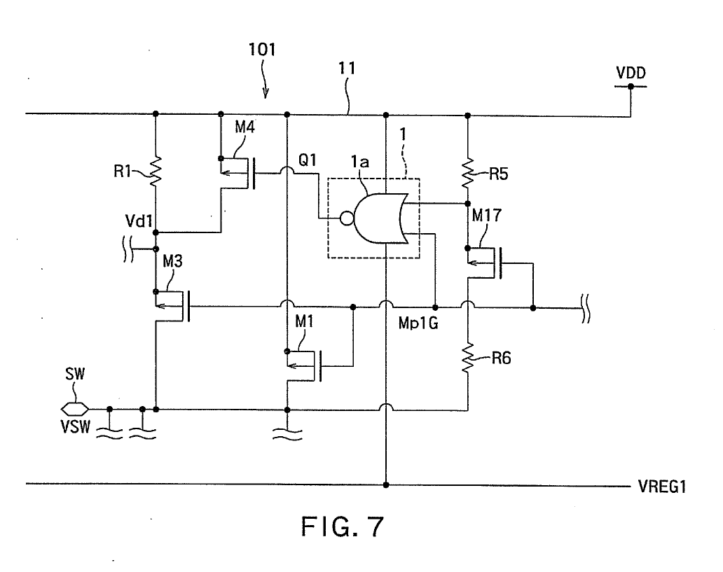

FIG. 7 illustrates an example of a circuit configuration featuring a configuration for detecting a ground fault of a short-circuit protection circuit according to the first modification. In FIG. 7, the same reference numerals as in FIG. 1 indicate the same configurations as those of FIG. 1.

As illustrated in FIG. 7, a short-circuit protection circuit 101 further includes a fifth resistor R5, a sixth resistor R6, and a seventeenth MOS transistor (pMOS transistor) M17 of a first conductivity type unlike in the circuit configuration of FIG. 1.

The fifth resistor R5 has one end connected to a first potential line 11. In other words, the power supply potential VDD is applied to one end of the fifth resistor R5.

A sixth resistor R6 is connected between the other end of the fifth resistor R5 and a switching terminal SW.

The seventeenth MOS transistor M17 is connected in series with the sixth resistor R6 between the other end of the fifth resistor R5 and the switching terminal SW and has a gate connected to the gates of first and third MOS transistors M1 and M3.

The gate of the seventeenth MOS transistor M17 is supplied with a first gate voltage signal Mp1G. The seventeenth MOS transistor M17 is turned on or off in synchronization with the first and third MOS transistors M1 and M3. Specifically, the first and third MOS transistors M1 and M3 are turned on in synchronization with the seventeenth MOS transistor M17 turning on, whereas the first and third MOS transistors M1 and M3 are turned off in synchronization with the seventeenth MOS transistor M17 turning off. For example, when the third MOS transistor M3 is turned on, that is, when a first comparator Comp1 can detect a short circuit, the seventeenth MOS transistor M17 is turned on.

Moreover, a NOR circuit la has an input connected to the switching terminal SW via the sixth resistor R6 and the seventeenth MOS transistor M17. A potential VREG1 between the power supply potential VDD and the ground potential VSS is supplied as an operating voltage to the NOR circuit la.

When the seventeenth MOS transistor M17 is turned on in the event of a detected short circuit, a potential difference between the power supply potential VDD and the terminal voltage VSW is divided by the fifth and sixth resistors R5 and R6 to obtain a voltage to be inputted to the NOR circuit la. Thus, the voltage inputted to the NOR circuit la can be reduced.

In this way, the short-circuit protection circuit 101 indirectly detects the terminal voltage VSW.

Other configurations and functions are identical to those of the DC-DC converter 100 illustrated in FIG. 1.

### Second Modification

A second modification will describe another example of a configuration for indirectly detecting a terminal voltage VSW in the case where a potential difference between a power supply potential VDD and a ground potential VSS is not smaller than the operating voltage of a logic circuit.

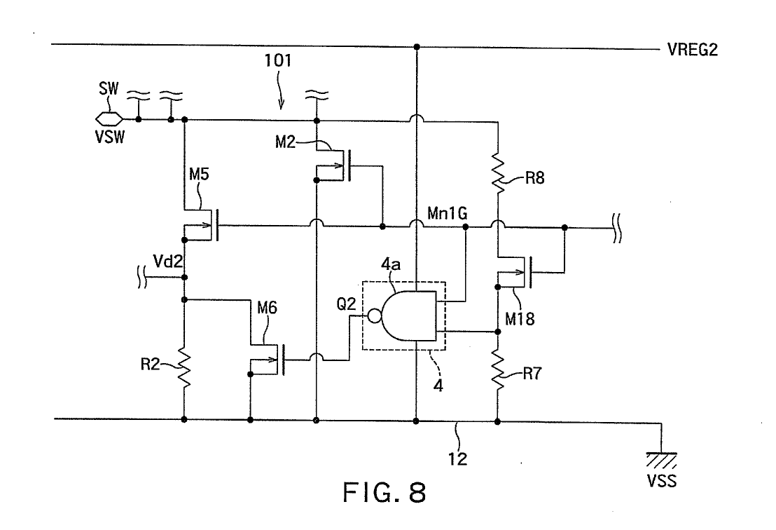

FIG. 8 illustrates an example of a circuit configuration featuring a configuration for detecting a ground fault of a short-circuit protection circuit according to the second modification. In FIG. 8, the same reference numerals as in FIG. 1 indicate the same configurations as those of FIG. 1.

As illustrated in FIG. 8, a short-circuit protection circuit 101 further includes a seventh resistor R7, an eighth resistor R8, and an eighteenth MOS transistor (nMOS transistor) M18 of a second conductivity type unlike in the circuit configuration of FIG. 1.

The seventh resistor R7 has one end connected to a second potential line 12. In other words, the ground potential VSS is applied to one end of the seventh resistor R7.

The eighth resistor R8 is connected between the other end of the seventh resistor R7 and a switching terminal SW.

The eighteenth MOS transistor M18 is connected in series with the eighth resistor R8 between the other end of the seventh resistor R7 and the switching terminal SW and has a gate connected to the gate of a second MOS transistor M2.

The gate of the eighteenth MOS transistor M18 is supplied with a second gate voltage signal Mn1G. The eighteenth MOS transistor M18 is turned on or off in synchronization with the second MOS transistor M2 and a fifth MOS transistor M5. Specifically, the second and fifth MOS transistors M2 and M5 are turned on in synchronization with the eighteenth MOS transistor M18 turning on, whereas the second and fifth MOS transistors M2 and M5 are turned off in synchronization with the eighteenth MOS transistor M18 turning off. For example, when the fifth MOS transistor M5 is turned on, that is, when a second comparator Comp2 can detect a short circuit, the eighteenth MOS transistor M18 is turned on.

Moreover, a NAND circuit 4a has an input connected to the switching terminal SW via the eighth resistor R8 and the eighteenth MOS transistor M18. A potential VREG2 between the power supply potential VDD and the ground potential VSS is supplied as an operating voltage to the NAND circuit 4a.

When the eighteenth MOS transistor M18 is turned on in the event of a detected short circuit, a potential difference between the terminal voltage VSW and the ground potential VSS is divided by the seventh and eighth resistors R7 and R8 to obtain a voltage to be inputted to the NAND circuit 4a. Thus, the voltage inputted to the NAND circuit 4a can be reduced.

In this way, the short-circuit protection circuit 101 indirectly detects the terminal voltage VSW.

Other configurations and functions are identical to those of the DC-DC converter 100 illustrated in FIG. 1.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A DC-DC converter comprising:
a first MOS transistor of a first conductivity type having a first end supplied with a first potential, a second end connected to a switching terminal, and a gate supplied with a first gate voltage signal;
a second MOS transistor of a second conductivity type having a first end connected to the switching terminal, a second end supplied with a second potential, and a gate supplied with a second gate voltage signal;
a controller controlling the first gate voltage signal and the second gate voltage signal to complementarily turn on or off the first MOS transistor and the second MOS transistor; and
a short-circuit protection circuit configured to detect a short circuit between the switching terminal and the first potential or the second potential, and output a detection signal to the controller,
the short-circuit protection circuit comprising:
a first resistor having a first end supplied with the first potential;
a third MOS transistor of the first conductivity type having a first end connected to a second end of the first resistor, a second end connected to the switching terminal, and a gate supplied with the first gate voltage signal, the third MOS transistor being turned on or off in synchronization with the first MOS transistor;
a fourth MOS transistor of the first conductivity type connected in parallel with the first resistor between the first potential line and the first end of the third MOS transistor, and controlled by a first logic signal;
a first logic circuit outputting the first logic signal so as to turn off the fourth MOS transistor in a case where the first gate voltage signal has a value that turns on the first MOS transistor and the switching terminal has a terminal voltage between a predetermined first threshold value and the second potential; and
a first detecting circuit comparing a first detected voltage between the second end of the first resistor and the first end of the third MOS transistor with a predetermined first reference voltage and outputting, in a case where the first detected voltage is closer to the second potential than the first reference voltage, a first detection signal indicating that the switching terminal and the second potential are short-circuited.

2. The DC-DC converter according to claim 1, wherein the controller turns off the first MOS transistor by the first gate voltage signal in response to the first detection signal.

3. The DC-DC converter according to claim 1, wherein the first logic circuit outputs the first logic signal so as to turn off the fourth MOS transistor in a case where the first gate voltage signal has a value that turns off the first MOS transistor or the terminal voltage is obtained between the first threshold value and the first potential.

4. The DC-DC converter according to claim 1, wherein the first detecting circuit compares the first detected voltage and the first reference voltage and does not output the first detection signal in a case where the first reference voltage is closer to the second potential than the first detected voltage.

5. The DC-DC converter according to claim 1, wherein the first logic circuit comprises a NOR circuit having an input connected to the switching terminal and the gate of the first MOS transistor, having an output connected to the gate of the fourth MOS transistor, and outputting the first logic signal.

6. The DC-DC converter according to claim 5, wherein the short-circuit protection circuit further comprises:
a fifth resistor having a first end supplied with the first potential;
a sixth resistor connected between a second end of the fifth resistor and the switching terminal; and
a seventeenth MOS transistor of the first conductivity type connected in series with the sixth resistor between the second end of the fifth resistor and the switching terminal and having a gate supplied with the first gate voltage signal, the seventeenth MOS transistor being turned on or off in synchronization with the first MOS transistor,
wherein the NOR circuit has an input connected to the switching terminal via the sixth resistor and the seventeenth MOS transistor.

7. A short-circuit protection circuit applicable to a DC-DC converter, the DC-DC converter comprising: a first MOS transistor of a first conductivity type having a first end supplied with a first potential, a second end connected to a switching terminal, and a gate supplied with a first gate voltage signal; a second MOS transistor of a second conductivity type having a first end connected to the switching terminal, a second end supplied with a second potential, and a gate supplied with a second gate voltage signal; and a controller controlling the first gate voltage signal and the second gate voltage signal to complementarily turn on or off the first MOS transistor and the second MOS transistor, the short-circuit protection circuit being configured to detect a short circuit between the switching terminal and the first potential or the second potential and output a detection signal to the controller,
the short-circuit protection circuit comprising:
a first resistor having a first end supplied with the first potential;
a third MOS transistor of the first conductivity type having a first end connected to a second end of the first resistor, a second end connected to the switching terminal, and a gate supplied with the first gate voltage signal, the third MOS transistor being turned on or off in synchronization with the first MOS transistor;
a fourth MOS transistor of the first conductivity type connected in parallel with the first resistor between the first potential line and the first end of the third MOS transistor and controlled by a first logic signal;
a first logic circuit outputting the first logic signal so as to turn off the fourth MOS transistor in a case where the first gate voltage signal has a value that turns on the first MOS transistor and the switching terminal has a terminal voltage between a predetermined first threshold value and the second potential; and
a first detecting circuit comparing a first detected voltage between the second end of the first resistor and the first end of the third MOS transistor with a predetermined first reference voltage and outputting, in a case where the first detected voltage is closer to the second potential than the first reference voltage, a first detection signal indicating that the switching terminal and the second potential are short-circuited.

8. The short-circuit protection circuit according to claim 7, wherein the first logic circuit outputs the first logic signal so as to turn off the fourth MOS transistor in a case where the first gate voltage signal has a value that turns off the first MOS transistor or the terminal voltage is obtained between the first threshold value and the first potential.

9. The short-circuit protection circuit according to claim 7, wherein the first detecting circuit compares the first detected voltage and the first reference voltage and does not output the first detection signal in a case where the first reference voltage is closer to the second potential than the first detected voltage.

10. The short-circuit protection circuit according to claim 7, wherein the first logic circuit comprises a NOR circuit having an input connected to the switching terminal and the gate of the first MOS transistor, having an output connected to the gate of the fourth MOS transistor, and outputting the first logic signal.

11. The short-circuit protection circuit according to claim 10, further comprising:
a fifth resistor having a first end supplied with the first potential;
a sixth resistor connected between a second end of the fifth resistor and the switching terminal; and
a seventeenth MOS transistor of the first conductivity type connected in series with the sixth resistor between the second end of the fifth resistor and the switching terminal and having a gate supplied with the first gate voltage signal, the seventeenth MOS transistor being turned on or off in synchronization with the first MOS transistor,
wherein the NOR circuit has an input connected to the switching terminal via the sixth resistor and the seventeenth MOS transistor.

12. The short-circuit protection circuit according to claim 7, wherein the first detecting circuit comprises:
a third resistor having a first end supplied with the first potential;
a seventh MOS transistor of the first conductivity type being diode-connected and having a first end connected to a second end of the third resistor;
an eighth MOS transistor of the second conductivity type having a first end connected to a second end of the seventh MOS transistor and a second end supplied with the second potential;
a ninth MOS transistor of the first conductivity type having a first end connected to the second end of the first resistor and a gate connected to a gate of the seventh MOS transistor;
a tenth MOS transistor of the second conductivity type having a first end connected to a second end of the ninth MOS transistor, a second end supplied with the second potential, and a gate connected to a gate of the eighth MOS transistor;
a first constant current source having a first end supplied with the first potential and outputting a constant current; and
an eleventh MOS transistor of the second conductivity type being diode-connected and having a first end connected to a second end of the first constant current source, a second end supplied with the second potential, and a gate connected to the gate of the eighth MOS transistor,
wherein the first detecting circuit outputs the first detection signal based on a voltage between the second end of the ninth MOS transistor and the first end of the tenth MOS transistor.

13. The short-circuit protection circuit according to claim 12, wherein the first detecting circuit further comprises
a first inverter supplied with a voltage between the second end of the ninth MOS transistor and the first end of the tenth MOS transistor and outputting the first detection signal.

14. The short-circuit protection circuit according to claim 7, further comprising:
a second resistor having a first end supplied with the second potential;
a fifth MOS transistor of the second conductivity type having a first end connected to a second end of the second resistor, a second end connected to the switching terminal, and a gate supplied with the second gate voltage signal, the fifth MOS transistor being turned on or off in synchronization with the second MOS transistor;
a sixth MOS transistor of the second conductivity type being connected in parallel with the second resistor between the second potential line and the first end of the fifth MOS transistor and controlled by a second logic signal;
a second logic circuit outputting the second logic signal so as to turn off the sixth MOS transistor in a case where the second gate voltage signal has a value that turns on the second MOS transistor and the terminal voltage is obtained between a predetermined second threshold value and the first potential; and
a second detecting circuit comparing a second detected voltage between the second end of the second resistor and the first end of the fifth MOS transistor with a predetermined second reference voltage and outputting, in a case where the second detected voltage is closer to the first potential than the second reference voltage, a second detection signal indicating that the switching terminal and the first potential are short-circuited.

15. The short-circuit protection circuit according to claim 14, wherein the second logic circuit outputs the second logic signal so as to turn off the sixth MOS transistor in a case where the second gate voltage signal has a value that turns off the second MOS transistor or the terminal voltage is obtained between the second threshold value and the second potential.

16. The short-circuit protection circuit according to claim 14, wherein the second detecting circuit compares the second detected voltage and the second reference voltage and does not output the second detection signal in a case where the second reference voltage is closer to the first potential than the second detected voltage.

17. The short-circuit protection circuit according to claim 7, wherein the second detecting circuit comprises:
a fourth resistor having a first end supplied with the second potential;
a twelfth MOS transistor of the second conductivity type being diode-connected and having a first end connected to a second end of the fourth resistor;
an thirteenth MOS transistor of the first conductivity type having a first end connected to a second end of the twelfth MOS transistor and a second end supplied with the first potential;
a fourteenth MOS transistor of the second conductivity type having a first end connected to the second end of the second resistor and a gate connected to a gate of the twelfth MOS transistor;
a fifteenth MOS transistor of the first conductivity type having a first end connected to a second end of the fourteenth MOS transistor, a second end supplied with the first potential, and a gate connected to a gate of the thirteenth MOS transistor;
a second constant current source having a first end supplied with the second potential and outputting a constant current; and
an sixteenth MOS transistor of the first conductivity type being diode-connected and having a first end connected to a second end of the second constant current source, a second end supplied with the first potential, and a gate connected to the gate of the thirteenth MOS transistor,
wherein the second detecting circuit outputs the second detection signal based on a voltage between the second end of the fourteenth MOS transistor and the first end of the fifteenth MOS transistor.

18. The short-circuit protection circuit according to claim 17, wherein the second detecting circuit further comprises
a second inverter supplied with a voltage between the second end of the fourteenth MOS transistor and the first end of the fifteenth MOS transistor and outputs the second detection signal.

19. The short-circuit protection circuit according to claim 14, wherein the second logic circuit comprises a NAND circuit having an input connected to the switching terminal and the gate of the second MOS transistor, having an output connected to the gate of the sixth MOS transistor, and outputting the second logic signal.

20. The short-circuit protection circuit according to claim 19, further comprising:
a seventh resistor having a first end supplied with the second potential;
an eighth resistor connected between a second end of the seventh resistor and the switching terminal; and
an eighteenth MOS transistor of the second conductivity type connected in series with the eighth resistor between the second end of the seventh resistor and the switching terminal and having a gate supplied with the second gate voltage signal, the eighteenth MOS transistor being turned on or off in synchronization with the second MOS transistor,
wherein the NAND circuit has an input connected to the switching terminal via the eighth resistor and the eighteenth MOS transistor.
